(19) United States
(12) Patent Application Publication
(10) Pub. No.: US 2001/0028798 A1
(43) Pub. Date: Oct. 11, 2001

(54) System and method for utilizing a motion detector when capturing visual information

(76) Inventors: Neal J. Manowitz, Mahwah, NJ (US); Eric D. Edwards, San Francisco, CA (US)

Correspondence Address: Gregory J. Koerner, Simon & Koerner LLP, Suite B, 10052 Pasadena Avenue, Cupertino, CA, 95014, US

(21) Appl. No.: 09/781,916

(22) Filed: Feb. 8, 2001

Related U.S. Application Data
(60) Provisional application No. 60/186,964, filed on Mar. 6, 2000.

(51) Int. Cl. G03B 17/48

(52) U.S. Cl. 396/429

(57) ABSTRACT

A system and method for utilizing a motion detector when capturing visual information includes a motion detector mechanism that generates one or more motion values corresponding to current motion characteristics of a camera device. A motion module may then analyze the one or more motion values with reference to either a motion threshold value or a motion lookup table to determine whether current motion conditions of the camera device are acceptable for capturing a well-focused image of a particular target object. In the event that current motion conditions are not acceptable, then the motion module may provide relevant feedback information to a system user regarding the current motion conditions of the camera device.

### CROSS-REFERENCE TO RELATED APPLICATIONS

This application relates to, and claims priority in, U.S. Provisional Patent Application Ser. No. 60/186,964, entitled “Out Of Focus Warning,” filed on Mar. 6, 2000. The foregoing related application is commonly assigned, and is hereby incorporated by reference.

### BACKGROUND SECTION

1. Field of the Invention

This invention relates generally to techniques for capturing visual information, and relates more particularly to a system and method for utilizing a motion detector when capturing visual information.

2. Description of the Background Art

Implementing effective methods for capturing visual information is a significant consideration for designers and manufacturers of contemporary electronic devices. However, effectively capturing visual information by utilizing electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced electronic device that effectively captures, processes, and displays digital image data may benefit from an efficient implementation because of the large amount and complexity of the digital data involved.

In many situations, various image capture characteristics may significantly affect a resultant image that is ultimately provided for viewing or other purposes by a system user. For example, image clarity and focus are important factors that typically affect the usefulness of a particular given set of captured image data.

Due to growing demands on system resources and substantially increasing data magnitudes, it is apparent that developing new techniques for capturing visual information is a matter of concern for related electronic technologies. Therefore, for all the foregoing reasons, developing effective systems for capturing visual information remains a significant consideration for designers, manufacturers, and users of contemporary electronic devices.

### SUMMARY

In accordance with the present invention, a system and method are disclosed for utilizing a motion detector when capturing visual information. Initially, in one embodiment, a system user preferably may select a motion sensor mode for the operation of a camera device using any effective means. For example, the system user may activate the motion sensor mode by utilizing a manual switch or button that is externally mounted on the camera device. Alternately, the system user may activate the motion sensor mode by utilizing a menu displayed on a user interface in a viewfinder of the camera device.

In certain embodiments, a motion module may then preferably determine and store a current shutter speed value and a current zoom setting value corresponding to the camera device. Next, the motion module may preferably monitor and store one or more current motion values from one or more motion detector(s) coupled to the camera device. In alternate embodiments, the motion module may similarly monitor and store one or more current autofocus values from an autofocus module of the camera device.

Then, the motion module may preferably compare one or more camera parameters to either a pre-determined motion threshold value or to a motion lookup table to thereby determine whether current motion conditions of the camera device are acceptable for capturing a well-focused image of a selected target object. In certain embodiments, the foregoing camera parameters may include at least one of the one or more current motion values, the one or more current autofocus values, a current shutter speed value, and a current zoom setting.

Next, if the motion conditions of the camera device are currently acceptable for capturing a well-focused image of the target object, the camera device may then capture image data corresponding to the target object in response to instructions from the system user. The process may then terminate.

However, if the motion conditions of the camera device are not currently acceptable for capturing a well-focused image, the motion module may then preferably provide feedback information relating to the unacceptable motion conditions of the camera device by using any effective and appropriate technique(s). In certain embodiments, the motion module may provide a visual or aural warning to the system user regarding the current excessive motion characteristics of the camera device. Alternately, the motion module may temporarily disable the capture of additional image data while unacceptable motion conditions exist with respect to the camera device.

After the motion module provides the foregoing feedback information relating to the current unacceptable motion conditions of the camera device, the motion module may continue to monitor and analyze motion values from the motion detector(s), until the motion module determines that current motion conditions of the camera device are acceptable. The camera device may then successfully capture a well-focused image of the target object, and the foregoing process may terminate. The present invention thus provides an improved system and method for utilizing a motion detector when capturing visual information.

### BRIEF DESCRIPTION OF THE DRAWINGS

FIG. 1 is a block diagram for one embodiment of a camera device, in accordance with the present invention;

FIG. 2 is a block diagram for one embodiment of the capture subsystem of FIG. 1, in accordance with the present invention;

FIG. 3 is a block diagram for one embodiment of the control module of FIG. 1, in accordance with the present invention;

FIG. 4 is a block diagram for one embodiment of the memory of FIG. 3, in accordance with the present invention;

FIG. 5 is a block diagram for one embodiment of the camera parameters of FIG. 4, in accordance with the present invention;

FIG. 6 is a flowchart of method steps for utilizing a motion detector when capturing visual information, in accordance with one embodiment of the present invention; and

FIG. 7 is a flowchart of method steps for utilizing a motion detector when capturing visual information, in accordance with one embodiment of the present invention.

### DETAILED DESCRIPTION

The present invention relates to an improvement in visual information capture techniques. The following description is presented to enable one of ordinary skill in the art to make and use the invention and is provided in the context of a patent application and its requirements. Various modifications to the disclosed embodiments will be readily apparent to those skilled in the art and the generic principles herein may be applied to other embodiments. Thus, the present invention is not intended to be limited to the embodiments shown, but is to be accorded the widest scope consistent with the principles and features described herein.

The present invention comprises a system and method for utilizing a motion detector when capturing visual information, and includes a motion detector mechanism that preferably may generate one or more motion values corresponding to current motion characteristics of a camera device. A motion module may then analyze the one or more motion values with reference to either a motion threshold value or a motion lookup table to thereby determine whether current motion conditions of the camera device are acceptable for capturing a well-focused image of a particular target object. In the event that current motion conditions are not acceptable, then the motion module may preferably provide relevant feedback information to a system user regarding the current motion conditions of the camera device.

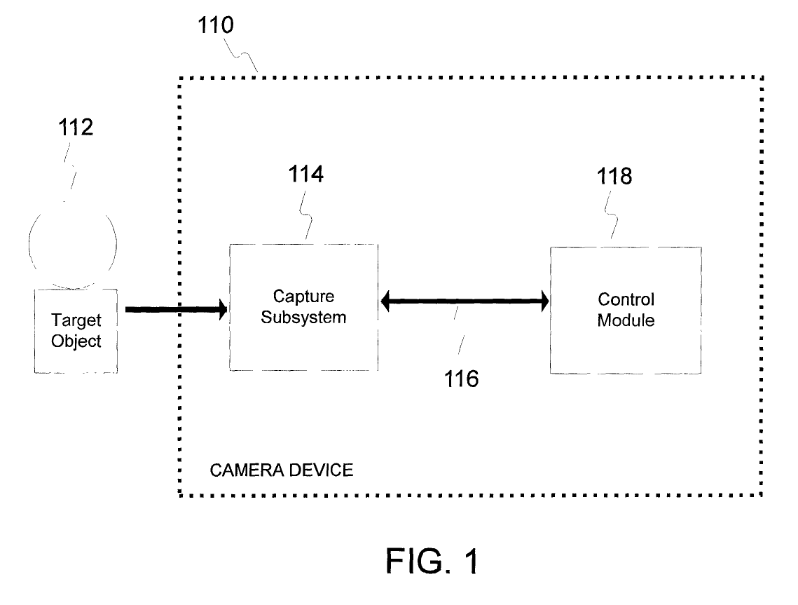

Referring now to FIG. 1, a block diagram for one embodiment of a camera device 110 is shown, in accordance with the present invention. In the FIG. 1 embodiment, camera device 10 may include, but is not limited to, a capture subsystem 114, a system bus 116, and a control module 118. Capture subsystem 114 may be optically coupled to a target object 112, and may also be electrically coupled via system bus 116 to control module 118. In alternate embodiments, camera device 110 may readily include various other components in addition to, or instead of, those components discussed in conjunction with the FIG. 1 embodiment. In addition, in certain embodiments, the present invention may alternately be embodied in any appropriate type of electronic device other than the camera device 110 of FIG. 1.

In the FIG. 1 embodiment, once a system user has focused capture subsystem 114 on target object 112 and requested camera device 110 to capture image data corresponding to target object 112, then control module 118 may preferably instruct capture subsystem 114 via system bus 116 to capture image data representing target object 112. The captured image data may then be transferred over system bus 116 to control module 118, which may responsively perform various processes and functions with the image data. System bus 116 may also bi-directionally pass various status and control signals between capture subsystem 114 and control module 118.

In alternate embodiments, camera device 110 may be implemented as a traditional camera device that captures images on photographic film. Camera device 110 may also be implemented as any other type of electronic imaging device, such as a scanner device or a video camera.

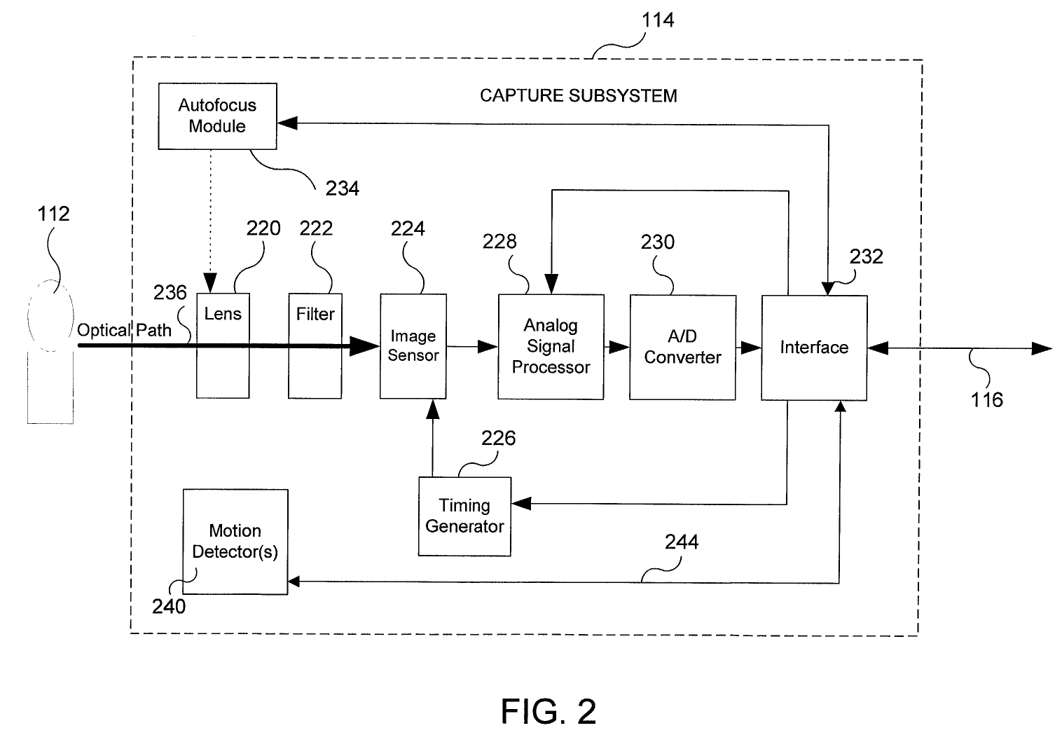

Referring now to FIG. 2, a block diagram for one embodiment of the FIG. 1 capture subsystem 114 is shown, in accordance with the present invention. In the FIG. 2 embodiment, imaging device 114 preferably comprises a lens 220 having an iris (not shown), a filter 222, an image sensor 224, a timing generator 226, an analog signal processor (ASP) 228, an analog-to-digital (A/D) converter 230, an interface 232, an autofocus module 234 to analyze and adjust the focus of lens 220, and one or more motion detector(s) 240. In alternate embodiments, capture subsystem 114 may readily include various other components in addition to, or instead of, those components discussed in conjunction with the FIG. 2 embodiment.

In the FIG. 2 embodiment, capture subsystem 114 may preferably capture image data corresponding to target object 112 via reflected light impacting image sensor 224 along optical path 236. Image sensor 224, which is preferably a charged-coupled device (CCD), may responsively generate a set of image data representing the target object 112. The image data may then be routed through ASP 228, A/D converter 230, and interface 232. Interface 232 may preferably include separate interfaces for controlling ASP 228, autofocus module 234, timing generator 226, autofocus module 234, and motion detector(s) 240. From interface 232, the image data passes over system bus 116 to control module 118.

In the FIG. 2 embodiment, motion detector(s) 240 may preferably include any appropriate means for detecting and capturing information regarding movement or shaking of camera device 110. In the FIG. 2 embodiment, motion detector(s) 240 may capture motion information using any effective methodology. For example, in certain embodiments, motion detector(s) 240 may include separate motion detectors that each detect movement of camera device 110 along a different axis (for example, a horizontal axis or a vertical axis).

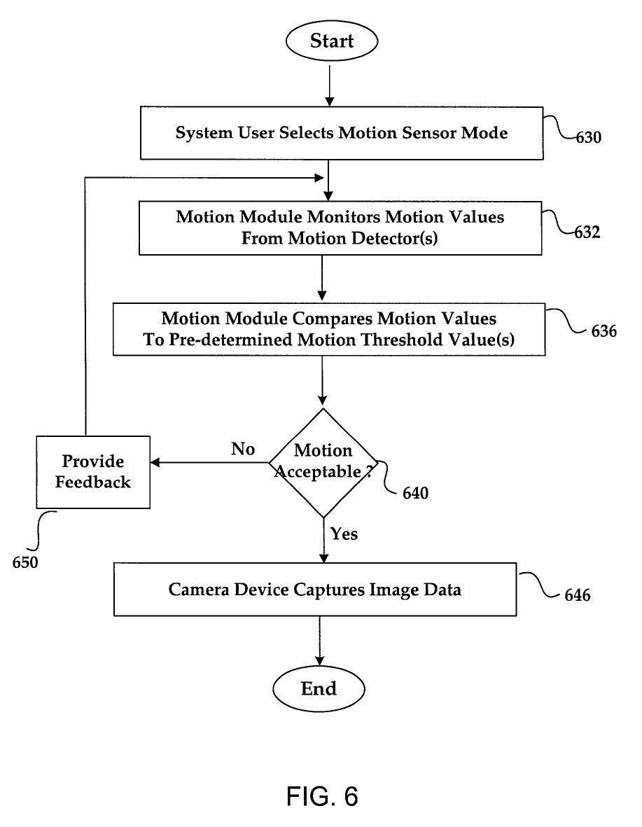

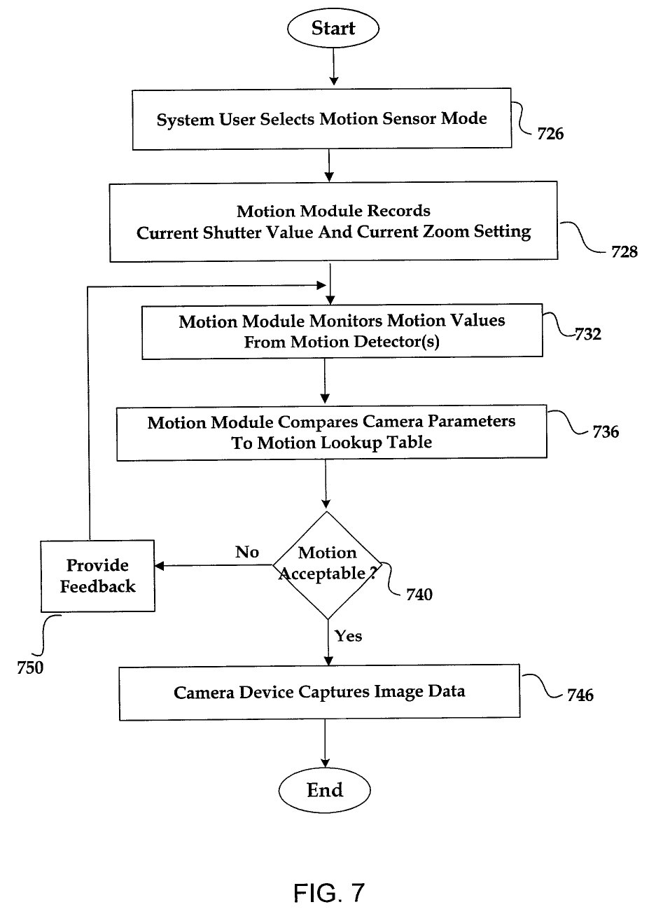

In the FIG. 2 embodiment, autofocus module 234 may generate one or more autofocus values using any effective technique(s). For example, autofocus module 234 may analyze target object 112 by scanning target object 112 along an indirect or a direct scan path to thereby generate focus values that preferably indicate a relative focus quality for a particular target object 112. Alternately, autofocus module 234 may also analyze contrast information from captured image data to generate the autofocus values. Excessive motion, instability, or shaking of capture subsystem 114 may typically result in inacceptable focus characteristics in captured image data corresponding to a given target object 112. The functionality and configuration of motion detector(s) 240 and autofocus module 234 are further discussed below in conjunction with FIGS. 6 and 7.

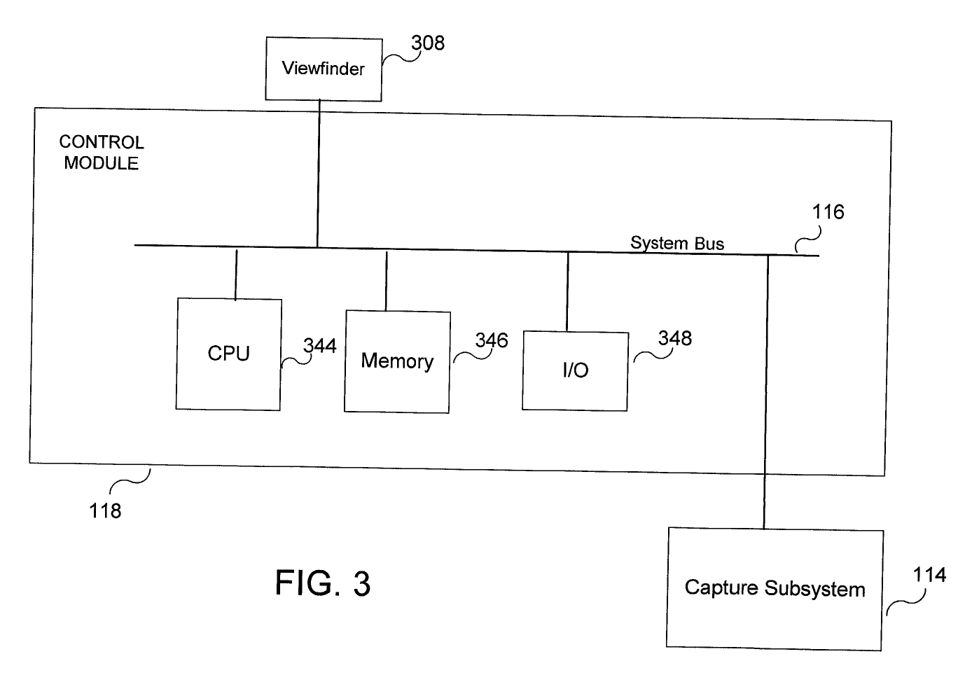

Referring now to FIG. 3, a block diagram for one embodiment of the FIG. 1 control module 118 is shown, in accordance with the present invention. In the FIG. 3 embodiment, control module 118 preferably includes, but is not limited to, a viewfinder 308, a central processing unit (CPU) 344, a memory 346, and an input/output interface (I/O) 348. Viewfinder 308, CPU 344, memory 346, and I/O 348 preferably are each coupled to, and communicate, via common system bus 116 that also communicates with capture subsystem 114. In alternate embodiments, control module 118 may readily include various other components in addition to, or instead of, those components discussed in conjunction with the FIG. 3 embodiment.

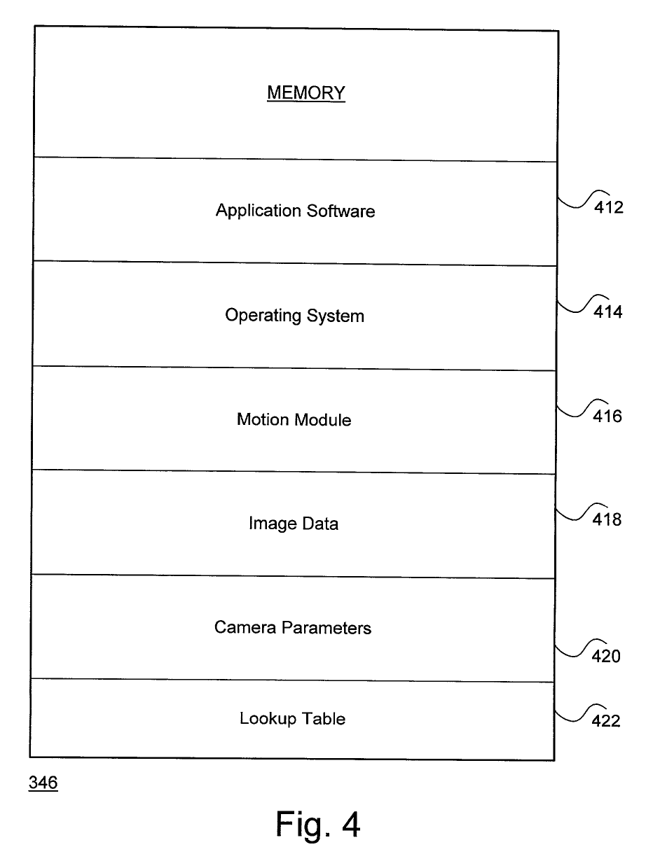

In the FIG. 3 embodiment, CPU 344 may preferably be implemented to include any appropriate microprocessor device. Memory 346 may preferably be implemented as one or more appropriate storage devices, including, but not limited to, read-only memory, random-access memory, and various types of non-volatile memory, such as floppy disc devices, hard disc devices, or flash memory. I/O 348 preferably may provide one or more effective interfaces for facilitating bidirectional communications between camera device 110 and any external entity, including a system user or another electronic device. I/O 348 may be implemented using any appropriate input and/or output devices. The operation and utilization of control module 118 is further discussed below in conjunction with FIGS. 4 through 7.

Referring now to FIG. 4, a block diagram for one embodiment of the FIG. 3 memory 346 is shown, in accordance with the present invention. In the FIG. 4 embodiment, memory 346 preferably includes, but is not limited to, application software 412, an operating system 414, a motion module 416, image data 418, camera parameters 420, and a motion lookup table 422. In alternate embodiments, memory 346 may readily include various other components in addition to, or instead of, those components discussed in conjunction with the FIG. 4 embodiment.

In the FIG. 4 embodiment, application software 412 may include software instructions that are preferably executed by CPU 344 (FIG. 3) to perform various functions and operations for camera device 110. The particular nature and functionality of application software 412 preferably varies depending upon factors such as the specific type and particular use of the corresponding camera device 110.

In the FIG. 4 embodiment, operating system 414 preferably controls and coordinates low-level functionality of camera device 110. In accordance with the present invention, motion module 416 preferably may monitor motion characteristics of camera device 110 and responsively provide feedback information to a system user regarding the corresponding effects of the foregoing motion characteristics upon focus quality of a proposed image capture event.

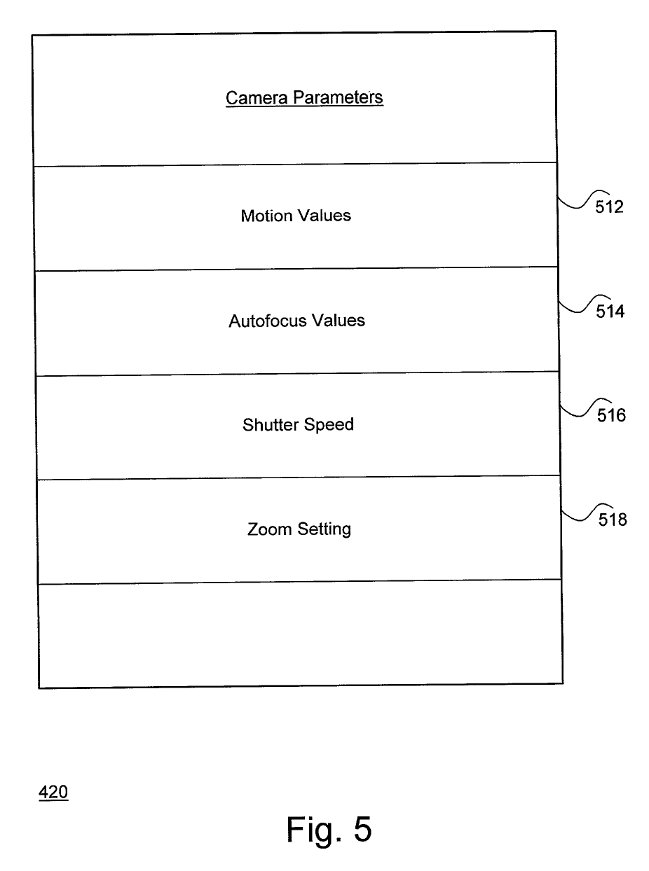

In the FIG. 4 embodiment, image data 418 may preferably include individual sets of image data that are each captured using capture subsystem 114 and responsively provided to control module 118, as discussed above in conjunction with FIG. 2. In accordance with the present invention, camera parameters 420 may include relevant information corresponding to associated sets of image data in memory 346. Camera parameters 420 are further discussed below in conjunction with FIG. 5.

In certain embodiments, motion module 416 may reference various camera parameters 420 to a lookup table 422 to thereby determine whether motion conditions of camera device 110 currently permit capturing a well-focused set of image data corresponding to target object 112. The operation of motion module 416 is further discussed below in conjunction with FIGS. 6 and 7.

Referring now to FIG. 5, a block diagram for one embodiment of the FIG. 4 camera parameters 420 is shown, in accordance with the present invention. In the FIG. 5 embodiment, camera parameters 420 preferably include, but are not limited to, one or more motion values 512, one or more autofocus values 514, a current shutter speed value 516, and a current zoom setting 518. In alternate embodiments, camera parameters 420 may readily include various other components and functions in addition to, or instead of, those components and functions discussed in conjunction with the FIG. 5 embodiment.

In the FIG. 5 embodiment, motion values 512 may include various types of information or data from one or more motion detector(s) 240 (FIG. 2) to indicate current relative motion characteristics of camera device 110. The foregoing movement or shaking of camera device 110 may result from any source. For example, the foregoing motion or shaking of camera device 110 may be produced by the manner in which a system user grasps, holds, or positions camera device 110.

In the FIG. 5 embodiment, autofocus values 514 may include focus information or data from an autofocus module 234 (FIG. 2) to indicate current relative focus characteristics of camera device 110 with respect to a chosen target object 112. Autofocus module 234 may preferably generate autofocus values 514 using any effective technique. For example, autofocus module 234 may sense contrast values from image data captured by image sensor 224 to generate corresponding autofocus values that indicate whether camera device 110 is currently focused on a selected target object 112.

In the FIG. 5 embodiment, shutter speed 516 may include one or more current values to identify a corresponding shutter speed of capture subsystem 114. In the FIG. 5 embodiment, shutter speed 516 may specify a time period during which image sensor 224 may be enabled to actively capture image data corresponding to a selected target object 112. In the FIG. 5 embodiment, zoom setting 518 may include one or more current values to identify a particular corresponding zoom setting of lens 220 from capture subsystem 114. In the FIG. 5 embodiment, zoom setting 518 may specify a specific relative frame size and apparent target proximity for a selected target object 112. The utilization of camera parameters is further discussed below in conjunction with FIGS. 6 and 7.

Referring now to FIG. 6, a flowchart of method steps for utilizing a motion detector 240 is shown, in accordance with one embodiment of the present invention. The FIG. 6 embodiment is presented for purposes of illustration, and, in alternate embodiments, the present invention may readily utilize various other steps and sequences than those discussed in conjunction with the FIG. 6 embodiment.

In the FIG. 6 embodiment, in step 630, a system user may preferably select a motion sensor mode for the operation of camera device 110 using any effective means. For example, the system user may activate or disable the motion sensor mode by utilizing a manual switch or button that is mounted on camera device 110. Alternately, the system user may activate or disable the motion sensor mode by utilizing a menu displayed on a user interface of viewfinder 308.

In step 632, motion module 416 may preferably monitor and store one or more current motion values 512 from motion detector(s) 240. In alternate embodiments, motion module 416 may similarly monitor and store one or more current autofocus values 514 from autofocus module 234.

Then, in step 636, motion module 418 may preferably compare the one or more stored current motion values 512 to one or more predetermined motion threshold value(s). Alternately, motion module 416 may similarly compare the one or more stored current autofocus values 514 to one or more predetermined focus threshold value(s). In the FIG. 6 embodiment, the foregoing motion threshold value(s) and focus threshold value(s) may be selected to respectively indicate a maximum motion level (for the motion threshold value(s)) or a minimum focus level (for the focus threshold value(s)) for acceptably capturing well-focused images of a selected target object 112.

In step 640, motion module 416 may preferably determine whether the motion characteristics of camera device 110 are acceptable under current circumstances and conditions, based upon the foregoing comparison procedure discussed in conjunction with step 636. If the motion of camera device 110 is currently acceptable for capturing a well-focused image of target object 112, then, in step 646, camera device 110 may capture image data 418 corresponding to target object 112 in response to instructions from the system user. The FIG. 6 process may then terminate.

However, in foregoing step 640, if the motion of camera device 110 is not currently acceptable for capturing a well-focused image of target object 112, then, in step 650, motion module 416 may preferably provide feedback relating to the unacceptable motion condition of camera device 110 using any effective and appropriate technique(s). In certain embodiments, motion module 416 may provide a visual or aural warning to the system user regarding the current excessive motion characteristics of camera device 110.

For example, camera device 110 may provide a flashing light or other indicia on an exterior surface of camera device 110. Camera device 110 may also provide a warning ikon or cautionary text in viewfinder 308. Similarly, camera device 110 may emit a warning sound or cautionary speech to warn the system user of excessive motion conditions. Alternately, motion module 416 may temporarily disable the capture of additional image data 418 while unacceptable motion conditions exist with respect to camera device 110.

After motion module 416 provides the foregoing feedback (step 650) relating to the current unacceptable motion conditions of camera device 110, the FIG. 6 process may preferably repeat steps 632, 636, and 640 until motion module 416 determines that current motion conditions of camera device 110 are acceptable. Camera device 110 may then successfully capture a well-focused image of target object 112 in step 646, and the FIG. 6 process may preferably terminate.

Referring now to FIG. 7, a flowchart of method steps for utilizing a motion detector 240 is shown, in accordance with one embodiment of the present invention. The FIG. 7 embodiment is presented for purposes of illustration, and, in alternate embodiments, the present invention may readily utilize various other steps and sequences than those discussed in conjunction with the FIG. 7 embodiment.

In the FIG. 7 embodiment, in step 726, a system user may preferably select a motion sensor mode for the operation of camera device 110 using any effective means. For example, the system user may activate or disable the motion sensor mode by utilizing a manual switch or button that is externally mounted on camera device 110. Alternately, the system user may activate or disable the motion sensor mode by utilizing a menu displayed on a user interface of viewfinder 308.

In step 728, motion module 416 may preferably determine and store a current shutter speed value 516 and a current zoom setting value 518, as discussed below in conjunction with FIG. 5. Then, in step 732, motion module 416 may preferably monitor and store one or more current motion values 512 from motion detector(s) 240. In alternate embodiments, motion module 416 may similarly monitor and store one or more current autofocus values 514 from autofocus module 234.

Then, in step 736, motion module 418 may preferably compare various camera parameters 420 to a motion lookup table 422 to determine whether current motion conditions of camera device 110 are acceptable for capturing a well-focused image of target object 112. In the FIG. 7 embodiment, the foregoing camera parameters 420 may include the current shutter speed value 516 and the current zoom setting 518 determined in step 728. The camera parameters 420 preferably may also include the one or more current motion values 512, and/or the one or more current autofocus values 514 from foregoing step 732.

In practice, a relatively shorter shutter speed value 516 may tolerate more motion in camera device 110 than a relatively longer shutter speed value 516, with respect to producing well-focused images of a given target object 112. Similarly, a relatively distant or “zoomed out” zoom setting value 518 may tolerate more motion in camera device 110 than a relatively close-up or “zoomed in” zoom setting value 518, with respect to producing well-focused images of a given target object 112.

In the FIG. 7 embodiment, motion lookup table 422 may be implemented and utilized in any effective manner. For example, in certain embodiments, motion module 416 may associate the foregoing camera parameters 420 to corresponding entries in the motion lookup table 422 to thereby cross-reference the camera parameters 420 to a resultant composite motion threshold value that indicates whether current motion conditions of camera device 110 are acceptable for producing a well-focused image.

In certain embodiments, motion module 416 may also apply separate weighting values to each of the camera parameters 420 before utilizing the motion lookup table 422, to thereby correct or adjust the camera parameters 420 for factors such as their relative importance or significance. In one embodiment, motion module 416 may utilize the foregoing weighting values and camera parameters 420 in accordance with the following formula.

F1(Motion Value)+F2(Shutter Value)+F3(Zoom Setting)=Composite Value

where F1 is a first weighting value, Motion Value is preferably a motion value 512 generated by motion detector(s) 240 (or an autofocus value 514 generated by autofocus module 234), F2 is a second weighting value, Shutter Value is a current shutter speed value 516, F3 is a third weighting value, Zoom Setting is a current zoom setting value 518, and Composite Value is a composite motion threshold value that motion detector 416 may reference to determine whether current motion conditions of camera device 110 are acceptable for producing a well-focused image.

In step 740, motion module 416 may preferably determine whether the motion characteristics of camera device 110 are acceptable under current circumstances and conditions, based upon the lookup table procedure of foregoing step 736. If the motion of camera device 110 is currently acceptable for capturing a well-focused image of target object 112, then, in step 746, camera device 110 may capture image data 418 corresponding to target object 112 in response to instructions from the system user. The FIG. 7 process may then terminate.

However, in foregoing step 740, if the motion of camera device 110 is not currently acceptable for capturing a well-focused image of target object 112, then, in step 750, motion module 416 may preferably provide feedback relating to the unacceptable motion conditions of camera device 110 using any effective and appropriate technique(s). In certain embodiments, motion module 416 may provide a visual or aural warning to the system user regarding the current excessive motion characteristics of camera device 110.

For example, camera device 110 may provide a flashing light or other indicia on an exterior surface of camera device 110. Camera device 110 may also provide a warning ikon or cautionary text in viewfinder 308. Similarly, camera device 110 may emit a warning sound or cautionary speech to warn the system user of excessive motion conditions. Alternately, motion module 416 may temporarily disable the capture of additional image data 418 while unacceptable motion conditions exist with respect to camera device 110.

After motion module 416 provides the foregoing feedback (step 750) relating to the current unacceptable motion conditions of camera device 110, the FIG. 7 process may preferably repeat steps 732, 736, and 740 until motion module 416 determines that current motion conditions of camera device 110 are acceptable. Camera device 110 may then successfully capture a well-focused image of target object 112 in step 746, and the FIG. 7 process may preferably terminate.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for capturing visual information with an imaging device, comprising:
a motion detector coupled to said imaging device for sensing motion information corresponding to said imaging device; and
a motion module configured to monitor said motion information, said motion module responsively providing feedback information regarding said motion information to a system user.

2. The system of claim 1 wherein said imaging device includes at least one of a digital still camera, a traditional film camera, a scanner device, and a video camera.

3. The system of claim 1 wherein said feedback information includes at least one of a visual warning, an aural warning, and an image-capture disable function.

4. The system of claim 1 wherein said feedback information alerts said system user that said imaging device currently has excessive motion characteristics that would prevent capturing a well-focused image of a selected target object.

5. The system of claim 1 wherein said motion detector includes a plurality of individual motion sensors that generate individual motion values that each correspond to a separate motion axis of said imaging device.

6. The system of claim 1 wherein said imaging device includes at least one of a capture subsystem, a viewfinder, and a control module, said capture subsystem including at least one of an autofocus module, a lens, and an image sensor, said control module including at least one of a central processing unit and a memory.

7. The system of claim 6 wherein said memory includes at least one of an application software program, an operating system, said motion module, image data, camera parameters, and a motion lookup table.

8. The system of claim 7 wherein said camera parameters include at least one of a motion value that corresponds to said motion information, an autofocus value that corresponds to said motion information, a current shutter speed value for said imaging device, and a current zoom setting for said imaging device.

9. The system of claim 1 wherein said system user activates a motion sensor mode for said imaging device by utilizing a user interface device coupled to said imaging device, said user interface device including at least one of a mode selector mechanism, a mechanical activation device mounted on an external surface of said imaging device, a voice-recognition system, and a menu representation in a graphical user interface presented on a viewfinder of said imaging device.

10. The system of claim 9 wherein said motion module monitors at least one of a current motion value generated by said motion detector and a current focus value generated by an autofocus module of said imaging device.

11. The system of claim 10 wherein said motion module compares at least one of said current motion value and said current focus value to one or more pre-determined motion threshold values that are selected to indicate when a current motion state of said imaging device is acceptable for capturing a well-focused image of a photographic target, said motion module responsively generating a positive capture decision when said current motion state is acceptable, and generating a negative capture decision when said current motion state is unacceptable.

12. The system of claim 11 wherein said imaging device captures said well-focused image in response to said positive capture decision, said motion module generating said feedback information in response to said negative capture decision.

13. The system of claim 12 wherein said feedback information includes at least one of a flashing light or other noticeable indicia on an exterior surface of said imaging device, a warning ikon or cautionary text in a viewfinder coupled to said imaging device, a warning sound or cautionary words from said imaging device, and a temporary disabling of an image capture function of said imaging device.

14. The system of claim 9 wherein said motion module records at least one of a current shutter setting value and a current zoom setting value corresponding to said imaging device.

15. The system of claim 14 said motion module monitors at least one of a current motion value generated by said motion detector and a current focus value generated by an autofocus module of said imaging device.

16. The system of claim 15 wherein said motion module references one or more camera parameters to a motion lookup table to thereby indicate when a current motion state of said imaging device is acceptable for capturing a well-focused image of a photographic target, said one or more camera parameters including at least one of said current motion value, said current focus value, said current shutter setting value, and said current zoom setting value, said motion module responsively generating a positive capture decision when said current motion state is acceptable, and generating a negative capture decision when said current motion state is unacceptable.

17. The system of claim 16 wherein said motion value may be relatively greater when said current shutter setting value is comparatively shorter, and wherein said motion value may be relatively greater when said current zoom setting value is comparatively zoomed-out.

18. The system of claim 16 wherein said motion module performs a weighting procedure on said camera parameters before referencing said camera parameters to said motion lookup table in accordance with a formula:
F1(Motion Value)+F2(Shutter Value)+F3(Zoom Setting)=Composite Value
where said F1 is a first weighting value, said Motion Value is generated by at least one of said motion detector and said autofocus module, said F2 is a second weighting value, said Shutter Value is said current shutter setting value, said F3 is a third weighting value, said Zoom Setting is said current zoom setting value, and said Composite Value is a composite motion threshold value that said motion detector may reference said motion lookup table to determine whether current motion conditions of said imaging device are acceptable for producing said well-focused image.

19. The system of claim 16 wherein said imaging device captures said well-focused image in response to said positive capture decision, said motion module generating said feedback information in response to said negative capture decision.

20. The system of claim 19 wherein said motion module continues to monitor said at least one of said current motion value and said current focus value, and repeatedly references said one or more camera parameters to said motion lookup table until said current motion state is acceptable, said motion module then generating said a positive capture decision, and said imaging device responsively capturing said well-focused image.

21. A method for capturing visual information with an imaging device, comprising the steps of:
sensing motion information corresponding to said imaging device by utilizing a motion detector coupled to said imaging device;
analyzing said motion information with a motion module; and
providing feedback information regarding said motion information to a system user.

22. The method of claim 21 wherein said imaging device includes at least one of a digital still camera, a traditional film camera, a scanner device, and a video camera.

23. The method of claim 21 wherein said feedback information includes at least one of a visual warning, an aural warning, and an image-capture disable function.

24. The method of claim 21 wherein said feedback information alerts said system user that said imaging device currently has excessive motion characteristics that would prevent capturing a well-focused image of a selected target object.

25. The method of claim 21 wherein said motion detector includes a plurality of individual motion sensors that generate individual motion values that each correspond to a separate motion axis of said imaging device.

26. The method of claim 21 wherein said imaging device includes at least one of a capture subsystem, a viewfinder, and a control module, said capture subsystem including at least one of an autofocus module, a lens, and an image sensor, said control module including at least one of a central processing unit and a memory.

27. The method of claim 26 wherein said memory includes at least one of an application software program, an operating system, said motion module, image data, camera parameters, and a motion lookup table.

28. The method of claim 27 wherein said camera parameters include at least one of a motion value that corresponds to said motion information, an autofocus value that corresponds to said motion information, a current shutter speed value for said imaging device, and a current zoom setting for said imaging device.

29. The method of claim 21 wherein said system user activates a motion sensor mode for said imaging device by utilizing a user interface device coupled to said imaging device, said user interface device including at least one of a mode selector mechanism, a mechanical activation device mounted on an external surface of said imaging device, a voice-recognition system, and a menu representation in a graphical user interface presented on a viewfinder of said imaging device.

30. The method of claim 29 wherein said motion module monitors at least one of a current motion value generated by said motion detector and a current focus value generated by an autofocus module of said imaging device.

31. The method of claim 30 wherein said motion module compares at least one of said current motion value and said current focus value to one or more pre-determined motion threshold values that are selected to indicate when a current motion state of said imaging device is acceptable for capturing a well-focused image of a photographic target, said motion module responsively generating a positive capture decision when said current motion state is acceptable, and generating a negative capture decision when said current motion state is unacceptable.

32. The method of claim 31 wherein said imaging device captures said well-focused image in response to said positive capture decision, said motion module generating said feedback information in response to said negative capture decision.

33. The method of claim 32 wherein said feedback information includes at least one of a flashing light or other noticeable indicia on an exterior surface of said imaging device, a warning ikon or cautionary text in a viewfinder coupled to said imaging device, a warning sound or cautionary words from said imaging device, and a temporary disabling of an image capture function of said imaging device.

34. The method of claim 29 wherein said motion module records at least one of a current shutter setting value and a current zoom setting value corresponding to said imaging device.

35. The method of claim 34 said motion module monitors at least one of a current motion value generated by said motion detector and a current focus value generated by an autofocus module of said imaging device.

36. The method of claim 35 wherein said motion module references one or more camera parameters to a motion lookup table to thereby indicate when a current motion state of said imaging device is acceptable for capturing a well-focused image of a photographic target, said one or more camera parameters including at least one of said current motion value, said current focus value, said current shutter setting value, and said current zoom setting value, said motion module responsively generating a positive capture decision when said current motion state is acceptable, and generating a negative capture decision when said current motion state is unacceptable.

37. The method of claim 36 wherein said motion value may be relatively greater when said current shutter setting value is comparatively shorter, and wherein said motion value may be relatively greater when said current zoom setting value is comparatively zoomed-out.

38. The method of claim 36 wherein said motion module performs a weighting procedure on said camera parameters before referencing said camera parameters to said motion lookup table in accordance with a formula:
F1(Motion Value)+F2(Shutter Value)+F3(Zoom Setting)=Composite Value
where said F1 is a first weighting value, said Motion Value is generated by at least one of said motion detector and said autofocus module, said F2 is a second weighting value, said Shutter Value is said current shutter setting value, said F3 is a third weighting value, said Zoom Setting is said current zoom setting value, and said Composite Value is a composite motion threshold value that said motion detector may reference said motion lookup table to determine whether current motion conditions of said imaging device are acceptable for producing said well-focused image.

39. The method of claim 36 wherein said imaging device captures said well-focused image in response to said positive capture decision, said motion module generating said feedback information in response to said negative capture decision.

40. The method of claim 39 wherein said motion module continues to monitor said at least one of said current motion value and said current focus value, and repeatedly references said one or more camera parameters to said motion lookup table until said current motion state is acceptable, said motion module then generating said a positive capture decision, and said imaging device responsively capturing said well-focused image.

41. A computer-readable medium comprising program instructions for capturing visual information by performing the steps of:
sensing motion information corresponding to an imaging device by utilizing a motion detector coupled to said imaging device;
analyzing said motion information with a motion module; and
providing feedback information regarding said motion information to a system user.

42. A system for capturing visual information with an imaging device, comprising:
means for sensing motion information corresponding to said imaging device;
means for analyzing said motion information; and
means for providing feedback information regarding said motion information to a system user.
